(19) United States
(12) Patent Application Publication
(10) Pub. No.: US 2011/0041934 A1
(43) Pub. Date: Feb. 24, 2011

(54) Delivery Pipline System

(76) Inventor: Gernold Holler, Wittingen (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/989,844

(22) PCT Filed: Apr. 9, 2009
(86) PCT No.: PCT/DE2009/000508

§ 371 Date: Oct. 27, 2010

(30) Foreign Application Priority Data
Apr. 28, 2008 (DE) 10 2008 021 201.6

(51) Int. Cl. F15D 1/02; F16L 9/18; F16L 19/00

(52) U.S. Cl. 137/561 R; 138/114; 285/123.3

(57) ABSTRACT

The invention relates to a delivery pipeline system of several pipeline sections (1) comprising an inner pipe (11) and an outer pipe (10), an insulating material (30) being arranged in an annular space (3) between the inner pipe (11) and the outer pipe (10) and the pipeline sections (1) being connected to each other by means of a pipe connector (2). The ends of the inner and outer pipes (11, 10) have threads (110, 100) which are configured at the pipe connector (2) to correspond to receiving threads (21, 20). The pipe connector (2) comprises tubular receiving devices (210, 200) which are arranged concentrically to one another. The invention further relates to a corresponding delivery pipe (1) and a pipe connector (2).

The invention relates to a delivery pipeline system comprising a number of pipeline sections with an inner pipe and an outer pipe, which is arranged at a radial distance around the inner pipe to form an annular space, an insulating material being arranged in the annular space between the inner pipe and the outer pipe and the pipeline sections being connected to one another by means of a pipe connector, and relates to a correspondingly formed delivery pipe and to a pipe connector for coupling two pipeline sections to one another.

Unlike transporting lines, delivery lines serve the purpose of delivering fluids from a great depth to the Earth's surface. These fluids may be either hydrocarbons or other, geothermally heated media, for example heated water. In principle, it is possible to drive delivery lines to great depths, using metal pipes that are connected to one another respectively at their ends. A disadvantage of this is the fact that a relatively great heat loss of the delivered medium occurs over the transporting path.

When delivery pipes are used for geothermal installations, it must be taken into consideration that the pressure on a pipe system increases in proportion with the increasing depth at which they are used. It should be assumed here that, for every 10 m of drilling depth, the prevailing pressure of water will increase by 1 bar, so that, at a drilling depth of 5000 m, the external pressure is 500 bar. To allow warm media to be transported over great distances with as little loss as possible, it is advantageous if the pipelines used are double-wall, metal pipes provided with an insulating layer between the two pipe bodies. These pipes are exposed to both great external pressures and great internal pressures. One possible way of insulating the inner pipe from the outer pipe is that they are provided with a defined gap, it being possible for the gap to be closed at the ends of the pipe, in order for example to achieve a vacuum on the principle of a thermos flask. As an alternative to evacuation, the intermediate space between the two pipes may be provided with an insulating material.

DE 198 37 317 C1 describes a steel jacket pipeline system for the underground transmission of district heat, which has an inner pipe which transports a heat transfer medium. Provided around the inner pipe is an annular insulation, which is surrounded by an outer jacket pipe. The insulating material is formed by PU foam, two pipe ends being connected by means of welding. Such a pipeline system is designed for running substantially horizontally and is not capable of withstanding high external compressive forces.

DE 91 01 196 U1 relates to a heat-insulated line pipe with an inner pipe which is connected at each of the ends to a connector formed as a spigot or socket element and is provided over its length with a thermal insulation which is arranged on the outer side, is enclosed by an outer pipe fixedly connected to the connectors and has through it centering rings distributed at unequal intervals over the length. The inner pipe is connected at its ends to the connectors by means of a friction weld. The outer pipe is fixedly connected to the connectors by means of a weld. The connectors have on the end remote from the inner pipe a threaded section, which is formed at one end as a socket element and at the other end as a spigot element. Here too, the pipe is used as a line pipe and not as a delivery pipe.

DE 32 18 729 C2 describes an insulating pipeline for underground drillings with an inner pipe and an outer pipe, between which an insulating layer is arranged. The extreme ends of the inner pipe and of the outer pipe are welded and the outer pipe is provided with an external thread, so that a number of pipeline ends can be connected to one another by means of an outer coupling.

On account of the pressures prevailing at great depths, it is necessary that the pipes for an insulating pipe, for example with an evacuated intermediate space, must each be considered individually in terms of statics, which has the consequence that the inner pipe must be dimensioned for a high internal pressure, while the outer pipe must be formed for a correspondingly high external pressure. This necessary dimensioning has the consequence that the wall thickness of the outer pipe at a depth of 5000 m will usually be thicker than 20 mm, because the pipe would otherwise collapse. The vacuum on the outer side of the inner pipe has the effect that the wall thickness of the inner pipe will also usually be thicker than 13 mm. This has the consequence that the total mass of the pipes becomes too great for the available crane capacities of a drilling rig to be able to handle the complete pipe run. Furthermore, the price for such a pipe run increases, so that such a setup is uneconomic.

The object of the present invention is therefore to provide a delivery pipeline system, delivery pipes and a pipe connector for delivery pipe sections with which it is also possible to work at great depths. According to the invention, this object is achieved by a delivery pipeline system with the features of claim 1, a delivery pipe with the features of claim 11 and a pipe connector with the features of claim 17. Advantageous configurations and developments of the invention are described in the respectively dependent subclaims.

The delivery pipeline system according to the invention comprising a number of pipeline sections with an inner pipe and an outer pipe, which is arranged at a radial distance around the inner pipe to form an annular space, an insulating material being arranged in the annular space between the inner pipe and the outer pipe and the pipeline sections being connected to one another by means of a pipe connector, provides that the ends of the inner and outer pipes have threads and that the pipe connector has receiving threads formed on tubular receiving devices so as to correspond to the pipe threads, and the receiving devices are fixed concentrically in relation to one another. The fact that the ends of the inner and outer pipes are spaced radially apart from one another and have threads which allow positive locking of the inner and outer pipes on the pipe connector to be performed with the pipe connector separately in each case makes it possible for a double-wall pipe and a double-wall delivery pipeline system to be realized, while maintaining an annular space also in the region of the pipe connectors and allowing an insulating material to be arranged between the inner pipe and the outer pipe. The tubular receiving devices make it possible to provide a continuous inner pipe which has no turbulence, or scarcely any turbulence, even at the transitions between the pipeline sections, so that favorable delivery characteristics are made possible. Likewise, the virtually uninterrupted annular space, including in the region of the pipe connectors, that is brought about by the receiving devices being fixed concentrically in relation to one another and at a distance from one another makes continuous insulation possible. At the same time, the stability of the double-wall pipes is maintained. Dispensing with welding of the pipeline sections avoids the heat treatment and structural transformation which welding involves and which generally causes a loss of strength. This loss of strength is unacceptable for use at great depths and with vertical orientation. Furthermore, on account of the screw connection, the delivery pipeline can be disassembled without destroying the pipeline sections, so that the components can be put to further use without having to be reconditioned.

The inner receiving device may be fixed in the outer receiving device by means of webs, so that, when the pipe connectors are connected to the ends of the pipes, simple assignment and simple screwing are possible as a result of the fixed assignment of the inner receiving device to the outer receiving device. Webs ensure that only an absolutely necessary number of connecting devices are used between the inner receiving device and the outer receiving device, so that there are as far as possible no heat bridges, or only minor heat bridges. At the same time, the webs perform stabilizing functions, so that mechanical stability of the overall pipe connector is provided.

The pipe threads and the receiving threads are preferably conically formed, to facilitate easy insertion of the respective threads and to compensate for alignment errors. The pipe threads are preferably formed as external threads, while the threads within the receiving devices are formed as internal threads.

Insulating material may likewise be arranged between the inner receiving device and the outer receiving device, in order to keep the heat losses as low as possible also in the region of the transition between two pipeline sections.

A development of the invention provides that the insulating material is stable under pressure, so that the pressure can be transferred from the outer pipe to the inner pipe and vice versa, and so the delivery pipe as a whole can be regarded as a single-wall system. This has the effect that the pipe wall thickness that can be used, that is to say the wall thickness of the inner pipe and the outer pipe, can be reduced considerably, since the same pressure lies on the pipe outer wall and pipe inner wall and the pressures equalize one another, because there is a direct force transmission from the inner wall of the inner pipe to the outer wall of the outer pipe. In the case of such a system, the efficiency of the delivery or transporting line is increased by a multiple and shortens the payback time of the overall installation considerably. In addition, the weight of the delivery pipeline system as a whole is reduced, and consequently also the costs for the material that is used and the handling as a result of the lower requirements for the handling technology.

While the annular gap between the inner pipe and the outer pipe in a pipeline section may already be provided with the insulating material in advance, it may be expedient for assembly reasons initially to provide the pipe connector with a free annular gap and only to fill it with an insulating material subsequently. For this purpose, it is provided that an insertion opening for the insulating material is formed in the receiving device and that the insulating material can be inserted through this opening after two pipeline sections have been connected, for example by screwing both the inner pipe and the outer pipe to the pipe connector, thereby allowing continuous insulation to be provided.

A development of the invention provides that the inner pipe is mounted in the outer pipe by means of one-sided displacement seats, so that it can be possible for the inner pipes to undergo length compensation as a result of the temperature difference and the different linear expansions. The displacement seats are of a sealed form to avoid leakage. It is likewise provided that the inner receiving device is mounted in the outer receiving device by means of one-sided displacement seats, in order likewise to be able to compensate for the changes in length.

It is possible that a foam material is used as insulating material. As a result, apart from high thermal insulation, effective force transmission from the inner pipe to the outer pipe and vice versa is at the same time ensured. The insulating material, which does not necessarily have to be a foam, preferably has a compressive strength of between 30 and 55 N/mm², in particular 35 to 50 N/mm², and a bending strength of between 12 and 25 N/mm², in particular between 12 and 20 N/mm². The preferred apparent density of the insulating material lies between 1350 and 1450 kg/m³, in particular between 1400 and 1410 kg/m³ with a thermal conductivity in the temperature range between 250° C. and 700° C. of between 0.55 and 0.40 W/mK, in particular between 0.50 and 0.45 W/mK. The insulating material is not restricted to foam; other insulating materials may likewise be used, provided that they are adequately stable under pressure and insulate. Material with improved characteristic values may likewise be used.

The delivery pipe according to the invention with an inner pipe and an outer pipe, which encloses the inner pipe to form an annular space, insulating material being arranged in the annular space, provides that the insulating material is formed in such a way as to transmit compressive force, in order to reduce the overall weight of the delivery pipe or the pipeline section without sacrificing mechanical strength, while at the same time providing improved thermal insulation in comparison with a single-wall delivery pipe or a delivery pipe with an evacuated annular gap.

The insulating material is preferably of an incompressible form, in order to ensure direct force transmission between the inner pipe and the outer pipe. This makes it possible to form very lightweight, high-strength lines, which allow driving to greater depths in order to allow energy reserves that are present at such depths to be exploited.

Threads, in particular external threads, are arranged at the ends of the pipes, to allow different pipeline lengths to be provided quickly and easily. The threads are preferably conically formed, in order to ensure insertion and screwing when there are unavoidable production tolerances. Length compensation of the inner pipes takes place by means of one-sided displacement seats, which are of a sealed form.

The pipe ends of the inner pipe and the outer pipe are in this case concentric and spaced radially apart from one another, so as to obtain a substantially straight pipe, the ends of which preferably lie in one plane, so that the inner pipes and outer pipes are of the same length. The annular space extends between the inner pipe and the outer pipe over the entire length and is optionally interrupted by webs for positioning the inner pipe within the outer pipe.

The pipe connector according to the invention for coupling two pipeline sections to one another, the pipeline sections having an inner pipe and an outer pipe, provides that the pipe connector has tubular receiving devices which are arranged concentrically in relation to one another and are fixed in relation to one another. This makes it possible on the one hand to couple the corresponding pipeline sections or delivery pipes with an inner pipe and an outer pipe to one another and on the other hand to provide a lightweight construction which has a free space formed between the inner receiving device and the outer receiving device, so that an insulating material or the like can be inserted within the free space. In the case of two receiving devices, that is to say in the case of a two-wall pipe, the inner receiving device and the outer receiving device are aligned with one another by means of webs, so that the inner receiving device is mounted in the outer receiving device by means of these webs. To allow length compensation, the inner receiving device is mounted in the outer receiving device by means of a one-sided displacement seat, which is of a sealed form, so that no fluid can escape in the region of the pipe connector.

A development of the invention provides that an insertion opening for insulating material is formed in the outer receiving device, so that, if the delivery pipes or pipeline sections to be connected already have insulation between the inner pipe and the outer pipe, subsequent insulation only has to be introduced at the pipe connectors. The insulation therefore only has to be introduced or applied in situ in the region of the joined separating points of the pipeline sections at the drilling site, it also being possible for the pipe connectors to be welded to the pipes.

Arranged between the inner and outer receiving devices is insulating material that is preferably of a kind that transmits compressive force, so that the overall stability of a delivery line, comprising delivery pipes and pipe connectors, is not adversely affected.

Exemplary embodiments are explained in more detail below on the basis of the accompanying figures. The same reference numerals designate the same components in the figures, in which:

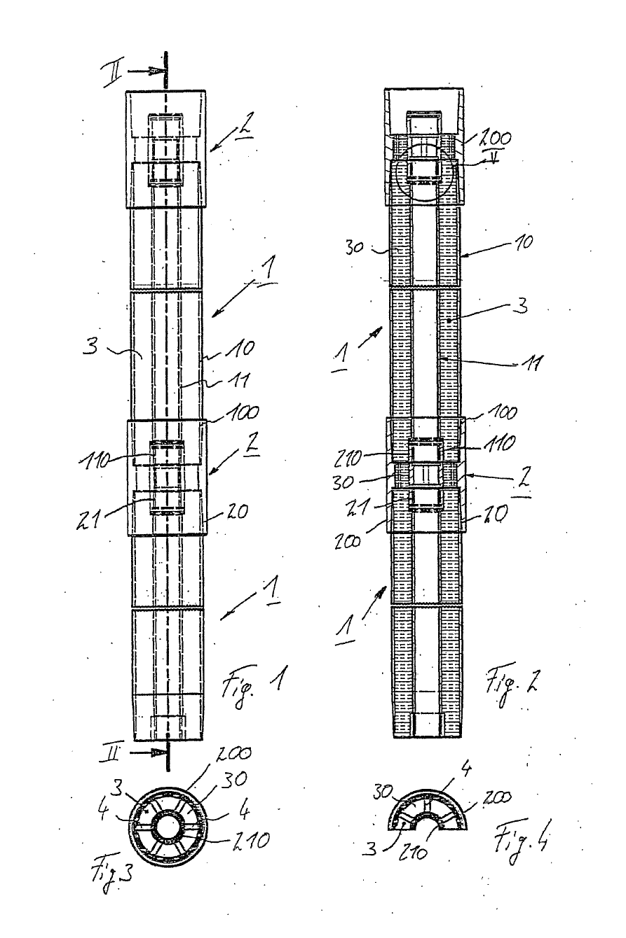

FIG. 1 shows a side view of a delivery pipeline system;

FIG. 2 shows a vertical section through a system as shown in FIG. 1;

FIG. 3 shows a plan view of FIG. 1;

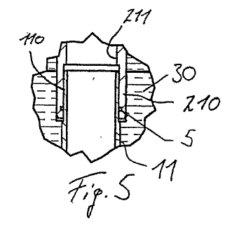

FIG. 4 shows a plan view of FIG. 2;

FIG. 5 shows a detail V as shown in FIG. 2;

FIG. 6 shows a side view of a pipe connector with a seal;

FIG. 7 shows a sectional representation along line VII-VII in FIG. 6;

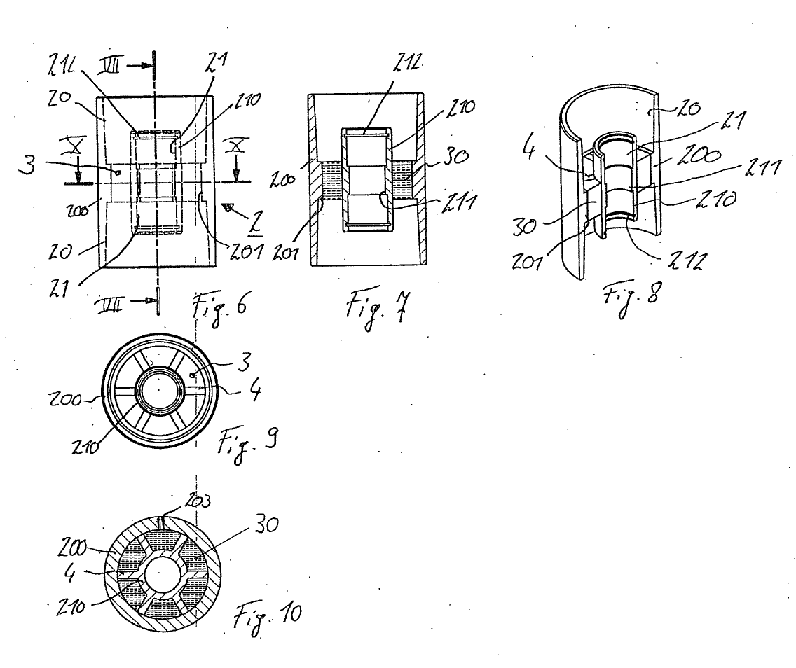

FIG. 8 shows a perspective sectional representation;

FIG. 9 shows a plan view of FIG. 6;

FIG. 10 shows a sectional representation along line X-X in FIG. 6;

FIG. 11 shows a side view of a variant of a delivery pipe system;

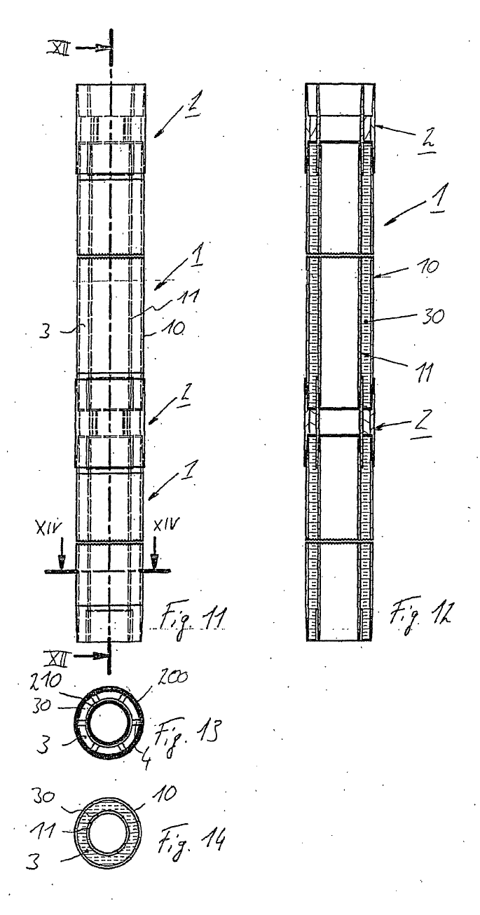

FIG. 12 shows a sectional representation along line XII-XII in FIG. 11;

FIG. 13 shows a plan view of FIG. 11;

FIG. 14 shows a sectional representation along line XIV-XIV in FIG. 11;

FIG. 15 shows a side view of a variant of a pipe connector;

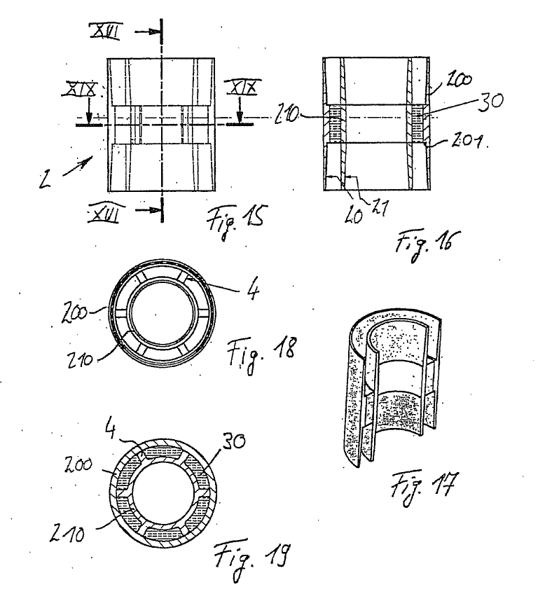

FIG. 16 shows a sectional representation along line XVI-XVI in FIG. 15;

FIG. 17 shows a perspective sectional representation of a pipe connector as shown in FIG. 15;

FIG. 18 shows a plan view as shown in FIG. 15; and

FIG. 19 shows a sectional representation along line XIX-XIX in FIG. 15.

FIG. 1 shows in a sectional representation a side view of a delivery pipe system which comprises a number of pipeline sections 1, which are connected to one another by means of pipe connectors 2. The pipeline sections 1 have an outer pipe 10 and an inner pipe 11, which are arranged radially at a distance from one another and one inside the other, so that an annular space 3 is formed between the outer pipe 10 and the inner pipe 11. At the pipe ends of the pipeline sections 1, threads 100, 110 are formed on the outer and inner pipes 10, 11, the pipe threads 110, 100 that are arranged on the inner and outer pipes 11, 10 being formed as external threads. In order to connect two pipeline sections 1 to one another, a pipe connector 2 is arranged between two pipeline sections and is connected to the pipeline sections 1 by means of the pipe threads 100, 110. For this purpose, it is provided that internal threads 20, 21 are provided within the pipe connector 2 and formed so as to correspond to the external threads 100, 110 of the outer pipe 10 and inner pipe 11. The internal threads 20, 21 are formed from tubular receiving devices 200, 210, which are arranged concentrically in relation to one another. An outer receiving device 200 surrounds the ends of the outer pipes 10 to be connected, while an inner receiving device 210 surrounds the ends of the inner pipes 11. To allow adequate geometrical stability to be provided even in the transitional region between the pipeline sections 1, the receiving devices 200, 210 are fixed in relation to one another, an annular space 3 forming between the inner side of the outer receiving device 200 and the outer side of the inner receiving device 210 and likewise being filled with an insulating material 30 in the same way as the annular space 3 between the inner and outer pipes 11, 10. The structural design of the double-wall pipeline section 1 and of the pipe connector 2 can be seen in FIG. 2. It can likewise be seen in FIG. 2 that the external threads 100, 110 of the outer and inner pipes 10, 11 are conically formed, in the same way as the receiving threads 20, 21 of the receiving devices 200, 210. The conical configuration of the threads 100, 110, 20, 21 makes it easier for the pipe connectors 2 to be screwed to the pipeline sections 1. Arranged at the end of the threads 20, 21 of the receiving devices 200, 210 are shoulders 201, 211, against which the pipe ends abut in the fully screwed state. The shoulders are dimensioned such that the respective inside diameter corresponds to the inside diameter of the pipes 10, 11, that is to say the inside diameter of the outer pipe 10 as well as the inside diameter of the inner pipe 11. In particular when the inner pipe 11 is arranged flush against the shoulder of the inner receiving device 210, a smooth transition is achieved at the connecting point, so that only a minimal amount of flow impairment occurs at the connecting point.

In FIGS. 3 and 4, plan views of the pipe connectors 2 arranged at the ends as shown in FIGS. 1 and 2 are represented. Here, the concentric arrangement of the receiving devices 200, 210 in relation to one another can be seen. The outer receiving device 200 surrounds the inner receiving device 210 to form an annular space 3. In order that the assignment of the inner and outer receiving devices 200, 210 is maintained, fixing is provided by means of webs 4, which fix the receiving devices 200, 210 in relation to one another. The annular space 3, which is interrupted by the webs 4, is likewise filled with insulating material 30, in order on the one hand to minimize heat conduction losses and on the other hand to make an additional contribution to the stability of the pipeline as a whole.

FIG. 5 shows an enlarged detail of the connecting point of the inner pipe 11 with the inner receiving device 210. For reasons of overall clarity, the other components are not shown. Arranged at the inside diameter of the receiving device 210 is a seal 5, which is of a peripheral form and seals the inner pipe 11 with the corresponding conical thread 110 with respect to the receiving device 210. This achieves the effect that reliable sealing of the pipeline as a whole occurs, even if the end of the inner pipe 11 does not come right up to the shoulder 211 of the inner receiving device 210 and seal the pipeline there by a press fit.

FIGS. 6-10 show details of the pipe connector 2 as shown in FIGS. 1 to 4, FIG. 6 presenting a side view. In FIG. 6, the receiving devices 200, 210 can be seen, with the conical internal threads 20, 21 tapering toward the middle of the pipe connector 2. Arranged within the internal thread 21 of the inner receiving device 210 is an annular groove 212, into which a sealing ring 5, for example an O-ring, can be placed. Formed between the inner receiving device 210 and the outer receiving device 200 is an annular space 3, which is filled with an insulating material 30, as can be seen in FIG. 7. In FIGS. 6 and 7 there can be seen the respective shoulders 201, 211 on the outer and inner receiving devices 200, 210, against which the ends of the outer and inner pipes 10, 11 can abut when they are fully screwed into the threads 20, 21. In FIGS. 8 to 10 it can be seen that the inner receiving device 210 is arranged concentrically in relation to the outer receiving device 200 and is held centrally within the outer receiving device 200 by means of webs 4 to form an annular space 3. Insulating material 30 is arranged within the annular space, which may be interrupted by the webs 4. The webs 4 extend radially outward in a star-shaped manner and radiate from the inner receiving device 210, the webs 4 being formed in one piece with the inner receiving device 210 in FIG. 10, which shows a sectional representation along the line X-X in FIG. 6. These webs may be inserted or shrink-fitted into the outer receiving device 200. Alternative possibilities for fastening the inner receiving device 210 in the outer receiving device 200 are possible; likewise, the webs 4 may be separately formed and fastened to the outer or the inner receiving device 200, 210, for example welded on. It is also possible to form the webs 4 on the outer receiving device 200.

The annular groove 212, which can be seen well in FIGS. 7 and 8 in particular, serves for receiving a seal 5 for the sealing of the outer circumference of the inner pipe 11. In principle, seals are also possible or provided in the axial end region of the pipes, so that they abut against the shoulders 201, 211 when the ends of the pipes are screwed in. As indicated in FIG. 10, a closable insertion opening 203, through which the insulating material 30 can be inserted into the annular space 3 between the outer receiving device 200 and the inner receiving device 210, may be provided on the outer receiving device 200. This makes it possible to fill the annular space 3 within the pipe connector 2 with insulating material 30 after the inner and outer pipes 11, 10 have been screwed to the pipe connector 2. It is advisable in this respect that the webs 4 are arranged or formed in such a way that the insulating material 30 can completely surround the inner receiving device 200 at the outer circumference. For this purpose, apertures or clearances are provided in the webs 4, or the webs 4 do not extend over the entire axial extent of the shoulder 201.

FIGS. 11 to 14 show a variant of the invention which substantially corresponds in structural design to the exemplary embodiment according to FIGS. 1 to 3. FIG. 11 shows a delivery pipeline system comprising a number of pipeline sections 1, which are connected to one another by means of pipe connectors 2. In comparison with the exemplary embodiment according to FIG. 1, however, the inside diameter of the inner pipe 11 is much greater than as it is shown in FIG. 1. As a result, the annular space 3 becomes narrower than in the exemplary embodiment as shown in FIG. 1, so that, as shown in FIG. 12, a smaller material thickness of the insulating material 30 can be arranged between the outer pipe 10 and the inner pipe 11. In FIG. 14, in which a section along XIV-XIV in FIG. 11 is represented, it can be seen that the inner pipe 11 is mounted concentrically within the outer pipe 10 and that between the outer pipe 10 and the inner pipe there is a peripheral annular space 3, which is completely filled with an insulating material 30.

FIGS. 15 to 19 show details of the pipe connector 2 according to the second embodiment, in which no separate sealing ring 5 is provided in an annular groove 212. As a further difference from the configuration of the pipe connector as shown in FIGS. 6 to 10, the inner shoulder 211 is not present on the inner receiving device 210, so that there is no end abutment of the inner pipe 11 against a shoulder. Here, too, webs 4 are arranged between the inner receiving device 210 and the outer receiving device 200, directed radially outward from the inner receiving device 210. As a result, the inner receiving device 210 is kept fixed in place in the outer receiving device 200.

Foams or other materials may be used as insulating material; materials that are stable under pressure and with which it is possible to transport high compressive forces from the inner pipe to the outer pipe are preferred. Insulating materials with a compressive strength of from 30 to 55 N/mm² and with a bending strength of between 12 and 25 N/mm² have been found to be particularly suitable. At the same time, the apparent density is between 1300 and 1500 kg/m³, in particular between 1400 and 1410 kg/m³. The thermal conductivity in a temperature range between 200° C. and 700° C. is preferably between 0.55 and 0.40 W/mK, preferably between 50 and 45 W/mK. These insulating materials have good thermal and electrical insulating properties, have high strength and thermal stability and can be machined very well. The insulating material may also be pushed into the outer pipe 10 and held therein, while the inner pipe 11 is pushed into a corresponding clearance in the insulating material. Screwing to the pipe connectors 2 produces a stable pipeline assembly. A fixed connection between the inner pipe 11 and the outer pipe 10 does not have to take place; rather, the inner pipe 11 may be displaceably mounted in the outer pipe 10, in order to compensate for different thermal expansions and resultant differences in length between the outer pipe 10 and the inner pipe 11 and, as a result, not put the stability of a pipeline at risk. This applies to the arrangement of the inner receiving device 210 in the outer receiving device 200, which may likewise be mounted by means of one-sided displacement seats in order to allow longitudinal displaceability of the receiving devices 200, 210 in relation to one another. Centering of the inner receiving device 10 in relation to the outer receiving device 200 is achieved both by means of the webs 4 and by means of the insulating material 3. Centering of the inner pipe 11 in relation to the outer pipe 10 is achieved by means of the insulating material 30. A one-sided displacement seat allows relative movement of the inner component in relation to the outer component in one direction, for example to make it possible to compensate for differences in length caused by thermal expansions.

The features of the exemplary embodiments may be combined with one another. Every disclosed feature can be used individually or in combination with other features, and the invention is not restricted to the combinations of features that are shown in the exemplary embodiments.

1. A delivery pipeline system comprising a number of pipeline sections (1) with an inner pipe (11) and an outer pipe (10), which is arranged at a radial distance around the inner pipe (11) to form an annular space (3), an insulating material (30) being arranged in the annular space (3) between the inner pipe (11) and the outer pipe (10) and the pipeline sections (1) being connected to one another by means of a pipe connector (2), characterized in that the ends of the inner and outer pipes (11, 10) have threads (110, 100) and in that the pipe connector (2) has receiving threads (21, 20) formed on tubular receiving devices (210, 200) so as to correspond to the pipe threads (110, 100), and the receiving devices (210, 200) are fixed concentrically in relation to one another.

2. The delivery pipeline system as claimed in claim 1, characterized in that the inner receiving device (210) is fixed in the outer receiving device (200) by means of webs (4).

3. The delivery pipeline system as claimed in claim 1, characterized in that the pipe threads (100, 110) and the receiving threads (20, 21) are conically formed.

4. The delivery pipeline system as claimed in claim 1, characterized in that the pipe threads (100, 110) are formed as external threads.

5. The delivery pipeline system as claimed in claim 1, characterized in that insulating material (30) is arranged between the inner receiving device (210) and the outer receiving device (200).

6. The delivery pipeline system as claimed in claim 1, characterized in that the insulating material (30) is stable under pressure.

7. The delivery pipeline system as claimed in claim 1, characterized in that an insertion opening (203) for the insulating material (30) is formed in the receiving device (200, 210).

8. The delivery pipeline system as claimed in claim 1, characterized in that the inner pipe (11) is mounted in the outer pipe (10) by means of one-sided displacement seats.

9. The delivery pipeline system as claimed in claim 1, characterized in that the inner receiving device (210) is mounted in the outer receiving device (200) by means of one-sided displacement seats.

10. The delivery pipeline system as claimed in claim 1, characterized in that a foam material is used as insulating material (30).

11. A delivery pipe with an inner pipe (11) and an outer pipe (10), which encloses the inner pipe (11) to form an annular space (3), an insulating material (30) being arranged in the annular space (3), characterized in that the insulating material (30) is formed in such a way as to transmit compressive force.

12. The delivery pipe as claimed in claim 11, characterized in that the insulating material (30) is of an incompressible form.

13. The delivery pipe as claimed in claim 11, characterized in that threads (200, 210), in particular external threads, are arranged at the ends of the pipes.

14. The delivery pipe as claimed in claim 13, characterized in that the threads (200, 210) are conically formed.

15. The delivery pipe as claimed in claim 11, characterized in that the inner pipe (11) is mounted in the outer pipe (10) in a centering manner by means of one-sided displacement seats, while leaving play in the longitudinal direction.

16. The delivery pipe as claimed in claim 11, characterized in that the pipe ends of the inner pipe (11) and the outer pipe (10) are arranged concentrically in relation to one another and radially at a distance from one another.

17. A pipe connector (2) for coupling two pipeline sections (1) to one another, the pipeline sections (1) having an inner pipe (11) and an outer pipe (10), characterized in that the pipe connector (2) has tubular receiving devices (200, 210) which are arranged concentrically in relation to one another and are fixed in relation to one another.

18. The pipe connector as claimed in claim 17, characterized in that there are two receiving devices (200, 210) and the inner receiving device (210) is mounted in the outer receiving device (200) by means of webs (4).

19. The pipe connector as claimed in claim 17, characterized in that the inner receiving device (210) is mounted in the outer receiving device (200) in a centering manner by means of a one-sided displacement seat, while leaving play in the longitudinal direction.

20. The pipe connector as claimed in claim 17, characterized in that an insertion opening (203) for insulating material (30) is formed in the outer receiving device (200).

21. The pipe connector as claimed in claim 17, characterized in that insulating material (30) is arranged between the inner and outer receiving devices (200, 210).

22. The pipe connector as claimed in claim 21, characterized in that the insulating material (30) is of a kind that transmits compressive force.
